(19) United States
(12) Patent Application Publication
(10) Pub. No.: US 2011/0129700 A1
(43) Pub. Date: Jun. 2, 2011

(54) BATTERY PACK

(75) Inventor: Wonki HONG, Yongin-si (KR)

(73) Assignee: SAMSUNG SDI CO., LTD., Yongin-si (KR)

(21) Appl. No.: 12/949,591

(22) Filed: Nov. 18, 2010

(30) Foreign Application Priority Data
Nov. 27, 2009 (KR) 10-2009-0115963

(51) Int. Cl. H01M 10/42

(52) U.S. Cl. 429/7

(57) ABSTRACT

A battery pack that easily replaces a protective circuit module according to a capacitance of battery cells and an external environment and including a commonly usable protective circuit module irrespective of an outer appearance of the battery pack. The battery pack includes a plurality of battery cells, a battery case in which the plurality of battery cells are disposed, a protective circuit part electrically connected to the battery cells, and a protective circuit module in which the protective circuit part is disposed. The battery case and the protective circuit module are physically separable from and connectable to each other.

### CROSS-REFERENCE TO RELATED APPLICATION

This application claims the benefit of Korean Patent Application No. 10-2009-0115963, filed Nov. 27, 2009, in the Korean Intellectual Property Office, the disclosure of which is incorporated herein by reference.

### BACKGROUND

1. Field

Aspects of the present invention relate to a battery pack.

2. Description of the Related Art

Generally, a battery pack used for portable external electrical devices, such as notebooks, personal digital assistants (PDAs), and camcorders, include a plurality of battery cells because of a limited capacitance of the respective battery cells.

Recently, a chargeable and dischargeable secondary battery is used as the battery pack. The charging and discharging efficiency of the secondary battery differ according to respective battery cells included in the secondary battery. Thus, the battery pack is generally connected to a circuit, such as a protective circuit module (PCM), that controls charging and discharging of each of the battery cells to perform uniform charging and discharging operations or a circuit that prevents the battery cells from being overcharged and overdischarged.

However, a typical commercial battery pack has a structure in which battery cells and the PCM are disposed in a case. Thus, due to this structure, it is difficult to replace the PCM according to a capacitance of the battery cells and external environment. Also, in the typical battery pack, since the PCM is changed in configuration according to the outer appearance and shape of the battery pack, it is difficult to commonly use the PCM. In other words, it is difficult to use a PCM designed for a specific battery pack in other different battery packs. Also, since a space in which the battery cells are disposed is not separated from a space in which the PCM is disposed, a short circuit of the PCM due to a contact between the PCM and a leaking electrolyte may occur when the electrolyte of the lithium ion battery leaks out.

### SUMMARY

Aspects of the present invention provide a battery pack that easily replaces a protective circuit module according to capacitance of battery cells and external environment and includes a commonly usable protective circuit module irrespective of an outer appearance of the battery pack.

Aspects of the present invention provide a battery pack including: a plurality of battery cells; a battery case in which the battery cells are disposed; a protective circuit part electrically connected to the battery cells; and a protective circuit module in which the protective circuit part is disposed, wherein the battery case and the protective circuit module are physically separable from and connectable to each other.

According to another aspect of the present invention, the battery case may include: a lower battery case in which the battery cells are disposed; and an upper battery case disposed on the lower battery case to cover the battery cells.

According to another aspect of the present invention, the protective circuit module may include: a body part receiving the protective circuit part therein; a first coupling terminal disposed on a lateral surface of the body part and electrically connected to a portable electrical device; and a second coupling terminal disposed on another lateral surface of the body part and electrically connected to the battery cells.

According to another aspect of the present invention, the battery case may include: a lower battery case in which the battery cells are disposed; and an upper battery case disposed on the lower battery case to cover the battery cells; a coupling slot defined in a lateral surface of the lower battery case and having an inwardly recessed groove shape to receive the second coupling terminal; and a conductive tab disposed on an exposed surface within the groove of the coupling slot and electrically connected to the battery cells.

According to another aspect of the present invention, the battery case may include a module receiving part disposed on a lateral surface of the battery case to receive the protective circuit module.

According to another aspect of the present invention, the battery case may include: a coupling slot formed on a lateral surface of the module receiving part and having an inwardly recessed groove shape to receive the second coupling terminal; and a conductive tab disposed on an exposed surface within the groove of the coupling slot and electrically connected to the battery cells.

According to another aspect of the present invention, when the protective circuit module is coupled to the battery case, an exposed surface of lateral surfaces of the battery case may be parallel to a surface on which the first coupling terminal of the body part is disposed.

According to another aspect of the present invention, the battery case may further include a coupling member disposed on another lateral surface of the module receiving part opposite to the lateral surface of the module receiving part in which the coupling slot is formed.

According to another aspect of the present invention, in the module receiving part of the battery case, the other lateral surface opposite to the lateral surface in which the coupling slot may be formed is recessed in an arc shape, and, in the protective circuit module, the other lateral surface opposite to the lateral surface on which the second coupling terminal is disposed is formed in an arc shape corresponding to the recessed arc shape.

According to another aspect of the present invention, the protective circuit module may further include a coupling groove formed in a shape corresponding to a shape of the coupling member of the battery case.

According to another aspect of the present invention, the protective circuit module may include: a body part receiving the protective circuit part; a first connector disposed on a lateral surface of the body part and electrically connected to a portable electrical device; and a second connector disposed on the other lateral surface of the body part and electrically connected to the plurality of battery cells.

According to another aspect of the present invention, the battery case may include a module receiving part disposed on a lateral surface of the battery case to receive the protective circuit module.

According to another aspect of the present invention, the battery case may include a connector receiving part disposed on a lateral surface of the module receiving part to receive the second connector, and the connector receiving part is electrically connected to the plurality of battery cells and the second connector.

According to another aspect of the present invention, when the protective circuit module is coupled to the battery case, an exposed surface of lateral surfaces of the battery case may be parallel to a surface on the protective circuit module on which a first connector of the body part is disposed.

According to another aspect of the present invention, the protective circuit module may further include coupling protrusions protruding outwardly from both lateral surfaces of the protective circuit module.

According to another aspect of the present invention, the battery case may further include inwardly recessed coupling grooves on both lateral surface of the module receiving part and each having a shape corresponding to respective one of the coupling protrusions.

According to another aspect of the present invention, the battery case may include at least one detachment member detaching the portable electrical device.

Aspects of the present invention provide a battery pack including: a plurality of battery cells; a lower battery case in which the plurality of battery cells are disposed; an upper battery case covering a portion of the lower battery case; a protective circuit part electrically connected to the plurality of battery cells; and a protective circuit module receiving the protective circuit part, wherein the protective circuit module may be disposed on lateral surfaces of the lower battery case and the upper battery case covering another portion of the lower battery case not covered by the upper battery case, and wherein the upper battery case or the lower battery case and the protective circuit module are physically separable from and connectable to each other.

According to another aspect of the present invention, the protective circuit module may include: a body part receiving the protective circuit part and surrounding a portion of the lower battery case and a lateral surface of the lower battery case; a connector disposed on an exposed surface of the body part and electrically connectable to a portable electrical device; and a coupling terminal electrically connecting the plurality of battery cells to the protective circuit part, wherein the coupling terminal couples the body part to the upper battery case or the lower battery case.

According to another aspect of the present invention, the lower battery case may include an inwardly recessed coupling slot disposed on a lateral surface to which the protective circuit part is coupled to receive the coupling terminal.

According to another aspect of the present invention, when the protective circuit module is coupled to the upper battery case and the lower battery case, a top surface of the upper battery case and a top surface of the protective circuit module may be parallel to each other.

According to another aspect of the present invention, when the protective circuit module is coupled to the upper battery case and the lower battery case, a lateral surface of the upper battery case, a lateral surface of the lower battery case, and a lateral surface of the protective circuit module may be parallel to each other.

According to another aspect of the present invention, when the protective circuit module is coupled to the upper battery case and the lower battery case, a bottom surface of the lower battery case and a bottom surface of the protective circuit module may be parallel to each other.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an exploded perspective view of a battery pack according to an embodiment of the present invention;

FIG. 2 illustrates a perspective view of a coupling state of a battery pack according to another embodiment of the present invention;

FIG. 3 illustrates an exploded perspective view of a battery pack according to another embodiment of the present invention;

FIG. 4 illustrates a perspective view of a coupling state of a battery pack according to another embodiment of the present invention;

FIG. 5 illustrates an exploded perspective view of a battery pack according to another embodiment of the present invention;

FIG. 6 illustrates a perspective view of a coupling state of a battery pack according to another embodiment of the present invention;

FIG. 7 illustrates an exploded perspective view of a battery pack according to another embodiment of the present invention;

FIG. 8 illustrates a bottom perspective view of a protective circuit module of a battery pack according to another embodiment of the present invention; and

FIG. 9 illustrates a perspective view of a coupling state of a battery pack according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

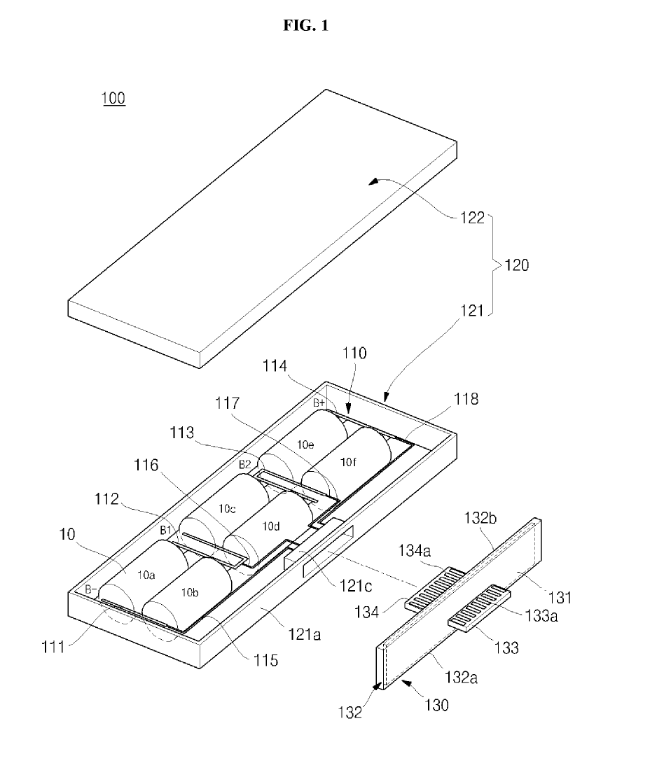

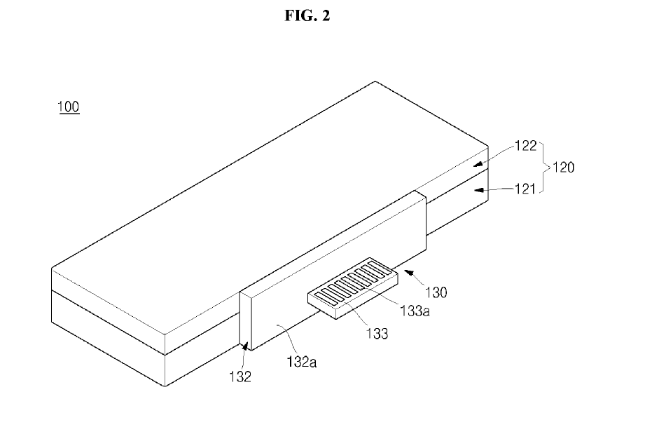

FIG. 1 illustrates an exploded perspective view of a battery pack according to an embodiment of the present invention, and FIG. 2 illustrates a perspective view of a coupling state of a battery pack according to another embodiment of the present invention. Referring to FIGS. 1 and 2, a battery pack 100, includes battery cells 10, a circuit part 110, a battery case 120, and a protective circuit module (PCM) 130.

A chargeable and dischargeable secondary battery is used as the battery cells 10. Specifically, a cylindrical lithium secondary battery having a high operating voltage of about 3.6 volts and a high energy density per unit weight is used as the battery cells 10. The battery cells 10 include six battery cells 10a, 10b, 10c, 10d, 10e, and 10f. However, aspects of the present invention are not limited thereto and a number of the battery cells 10 may vary. The battery cells 10 are designed so that a top surface and a bottom surface of each of the battery cells 10 have polarities different from each other. For example, the bottom surfaces of the battery cells 10 is electrically connected to a negative electrode of an electrode assembly (not shown) of the battery case 120, and the top surfaces of the battery cells 10 is electrically connected to a positive electrode of the electrode assembly (not shown) within the battery cells 10 of the battery case 120. However, aspects of the present invention are not limited thereto, and the battery cells 10 may be connected in other suitable configurations.

The circuit part 110 includes first to fourth conductive plates 111, 112, 113, and 114 and first to fourth conductive tabs 115, 116, 117, and 118. In FIG. 1, reference symbols B+ and B− represent large current terminals and power source parts of both ends of corresponding ones of the battery cells 10 connected in series or in parallel. The reference symbol B− represents a low potential terminal as a negative power source part, and the reference symbol B+ represents a high potential terminal as a positive power source part. Reference symbols B1 and B2 represent sensing terminals that are portions at which the battery cells 10 having different polarities are connected to each other in series. The respective sensing terminals B1 and B2 correspond to an intermediate potential terminal between the high potential terminal and the low potential terminal.

The first conductive plate 111 is electrically connected to negative electrodes of the two battery cells 10a and 10b disposed at a lower end of the battery cells 10, or in other words, the lowest potential terminal B−. The second conductive plate 112 has a bent portion so that it bends back upon itself. The two battery cells 10a and 10b of the battery cells 10 are electrically connected to each other in parallel at a side of the bent portion of the second conductive plate 112. Also, the two battery cells 10c and 10d of the battery cells 10 are electrically connected to each other in parallel at another side of the bent portion of the second conductive plate 112. The two battery cells 10a and 10b disposed at one side of the bent portion and the two battery cells 10c and 10d disposed at the other side of the bent portion are connected in series by the second conductive plate 112. The third conductive plate 113 has a bent portion so that it bends back upon itself. The two battery cells 10c and 10d of the battery cells 10 are electrically connected to each other in parallel at a side of the bent portion of the third conductive plate 113. The two battery cells 10e and 10f of the battery cells 10 are electrically connected to each other in parallel at another side of the bent portion of the third conductive plate 113. The two battery cells 10c and 10d disposed at a side of the bent portion and the two battery cells 10e and 10f disposed at another side of the bent portion are connected in series by the third conductive plate 112. The fourth conductive plate 114 is electrically connected to positive electrodes of the two battery cells 10e and 10f disposed at an upper end of the battery cells 10, i.e., the high potential terminal B+. The first to fourth conductive plates 111, 112, 113, and 114 are formed of any one of nickel (Ni), copper (Cu), or aluminium (Al). However, aspects of the present invention are not limited thereto and the first to fourth conductive plates 111, 112, 113 and 114 may be formed of other suitable materials. Also, it would be understood by one of ordinary skill in the art that when the number of the battery cells 10 increases, the number of the conductive plates increases accordingly.

The first conductive tab 115 has an end electrically connected to the first conductive plate 111 of the low potential terminal B− and another end facing a surface of the battery case 120. The second conductive tab 116 and the third conductive tab 117 each have an end electrically connected to the second conductive plate 112 and the third conductive plate 113, respectively, and other ends facing a surface of the battery case 120. The fourth conductive tab 118 has an end electrically connected to the fourth conductive plate 114 of the high potential terminal B+ and another end facing a surface of the battery case 120. A power of the battery cells 10 is supplied to a portable electrical device connected to the battery pack 100 through the first conductive tab 115 and the fourth conductive tab 118. However, aspects of the present invention are not limited thereto and other conductive tabs 115 to 118 may be used to supply power to the portable electrical device. Also, the first to fourth conductive tabs 115, 116, 117, and 118 are formed of Ni. Coated conductive wires may be used as the first to fourth conductive tabs 115, 116, 117, and 118. However, aspects of the present invention are not limited thereto and other suitable materials may be used to form the first through fourth conductive tabs 115 to 118.

The first to fourth conductive plates 111, 112, 113, and 114 and the first to fourth conductive tabs 115, 116, 117, and 118 are connected to each other using various methods according to configurations and dispositions of the battery cells 10.

The battery case 120 includes a lower battery case 121 and the upper battery case 122. The lower battery case 121 has a box shape with an opened upper portion. Also, the lower battery case 121 is configured to directly receive the battery cells 10 and the circuit part 110. A coupling slot 121c is disposed at a lateral surface 121a of the lower battery case 121. A portion of the lateral surface 121a of the lower battery case 121 is recessed to define the coupling slot 121c having a groove shape. The coupling slot 121c is electrically connected to the battery cells 10 through the first to fourth conductive plates 111, 112, 113, and 114 and the first and fourth conductive tabs 115, 116, 117, and 118. A conductive tab (not shown) electrically connected to a protective circuit part 131 is disposed on an outer surface of the groove of the coupling slot 121c. The lower battery case 121 is formed of an insulating resin. However, aspects of the present invention are not limited thereto and the lower battery case 121 may be formed of other suitable materials.

The upper battery case 122 may have a box shape with an opened lower portion. The upper battery case 122 may have a size corresponding to that of the opened upper portion of the lower battery case 121. The upper battery case 122 may be formed of an insulating resin. The upper battery case 122 and the lower battery case 121 are coupled to each other to protect the battery cells 10 and the circuit part 110 from external environment such as external impacts and dusts.

The PCM 130 includes the protective circuit part 131, a body part 132, a first coupling terminal 133, and a second coupling terminal 134. The protective circuit part 131 is electrically connected to the coupling slot 121c through the second coupling terminal 134. As a result, the protective circuit part 131 is electrically connected to the battery cells 10 through the first to fourth conductive plates 111, 112, 113, and 114 and the first to fourth conductive tabs 115, 116, 117, and 118. The protective circuit part 131 controls charging and discharging of the battery cells 10 through a circuit (not shown) disposed therein to prevent the battery cells 10 from being overcharged and overdischarged.

The body part 132 has a bar shape with an empty space therein. The body part 132 receives the protective circuit part 131 therein. An insulating resin is molded to form the body part 132. However, aspects of the present invention are not limited thereto and other materials may be used to form the body part 132.

The first coupling terminal 133 is disposed on a lateral surface 132a of the body part 132. The first coupling terminal 133 is inserted into a slot (not shown) disposed in the portable electrical device. The first coupling terminal 133 may have a plate shape. A conductive tab 133a is electrically connected to the protective circuit part 131 and is exposed from the first coupling terminal 133 so that it is electrically connected to the portable electrical device.

The second coupling terminal 134 is disposed on another lateral surface 132b of the body part 132. The second coupling terminal 134 has a shape corresponding to a shape of the coupling slot 121c of the battery case 120. That is, the second coupling terminal 134 has a plate shape. The second coupling terminal 134 is inserted into the coupling slot 121c of the battery case 120. A conductive tab 134a is electrically connected to the protective circuit part 131 and is exposed from the second coupling terminal 134 so that it is electrically connected to a conductive tab (not shown) of the coupling slot 121c. Since the coupling slot 121c is electrically connected to the battery cells 10, when the PCM 130 is coupled to the battery case 120, the protective circuit part 131 is electrically connected to the battery cells 10.

As described above, the battery case 120 and the PCM 130 are electrically connected to each other and the PCM 120 and the portable electrical device are electrically connected to each other as well as firmly coupled to each other by the first coupling terminal 133 and the second coupling terminal 134. Thus, in the battery pack 100 according to the present embodiment, a separate detachment member for coupling the battery case 120 or the PCM 130 to the portable electrical device is not required.

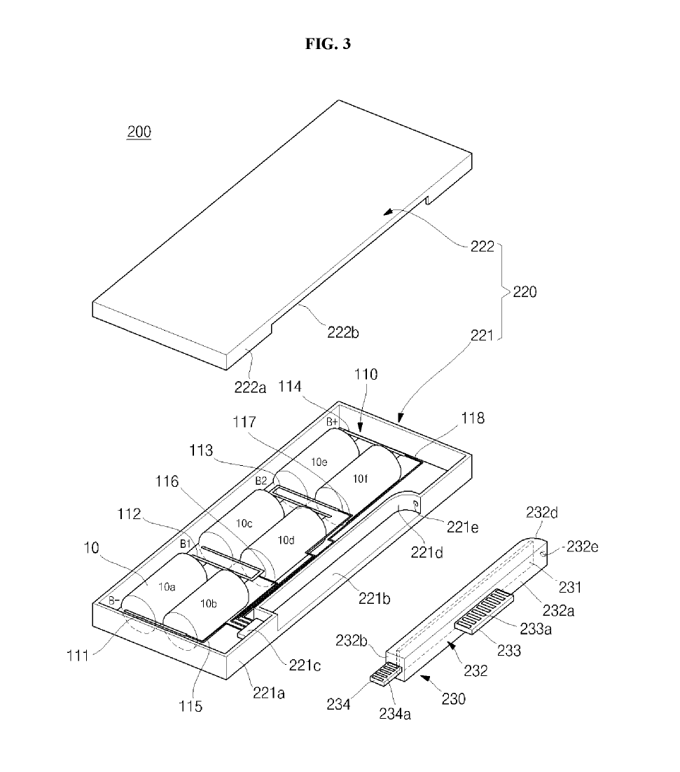

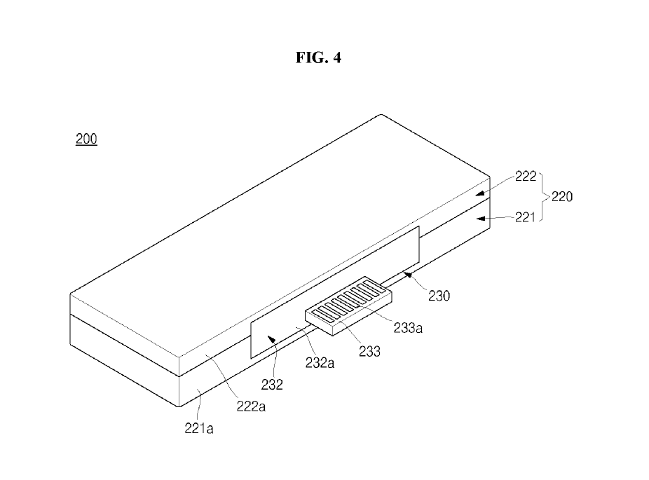

FIG. 3 illustrates an exploded perspective view of a battery pack according to another embodiment of the present invention, and FIG. 4 illustrates a perspective view of a coupling state of a battery pack according to another embodiment of the present invention. Referring to FIGS. 3 and 4, a battery pack 200 is different from the battery pack 100 of FIGS. 1 and 2 with respect to a battery case 220 and a protective circuit module (PCM) 230. Thus, in descriptions of the battery pack 200 according to the present embodiment, the battery case 220 and the PCM 230 will be mainly described. Also, parts equal to or similar to those of the battery pack 100 of FIGS. 1 and 2 have the same reference numerals, and the detailed descriptions will be omitted.

The battery case 220 includes a lower battery case 221 and an upper battery case 222. The lower battery case 221 has a box shape with an opened upper portion. Also, the lower battery case 221 is configured to directly receive battery cells 10 and a circuit part 110. A recessed module receiving part 221b is disposed in a lateral surface 221a of the lower battery case 221 to receive the PCM 230. A coupling slot 221c having an inwardly recessed groove shape is disposed in a lateral surface of the module receiving part 221b to receive the PCM 230. The coupling slot 221c is electrically connected to the battery cells 10 through first to fourth conductive tabs 115, 116, 117, and 118 and first to fourth conductive plates 111, 112, 113, and 114. A conductive tab (not shown) is electrically connected to a protective circuit part 231 and is disposed on an exposed surface within the groove of the coupling slot 221c. A recessed portion having an arc shape 221d is disposed on a lateral surface opposite to the lateral surface 221a in the module receiving part 221b. The arc shape 221d allows the PCM 230 to be smoothly coupled to the battery case 220. A protruding coupling member 221e is disposed on a portion of the arc shape 221d to firmly couple the PCM 230 to the battery case 220. Also, the lower battery case 221 is formed of an insulating resin. However, aspects of the present invention are not limited thereto and the lower battery case 221 may be formed of other suitable materials.

The upper battery case 222 has a box shape with an opened lower portion. The upper battery case 222 has a size and configuration corresponding to the size and configuration of the opened upper portion of the lower battery case 221. Specifically, a module receiving part 222b receiving the PCM 230 is defined in a lateral surface 222a of the upper battery case 222. An inwardly recessed arc shape (not shown) corresponding to the arc shape 221d is formed in a lateral surface of the module receiving part 222b. Also, the upper battery case 222 is formed of an insulating resin. However, aspects of the present invention are not limited thereto and the upper battery case 222 may be formed of other suitable materials.

The PCM 230 includes a protective circuit part 231, a body part 232, a first coupling terminal 233, and a second coupling terminal 234. The protective circuit part 231 is electrically connected to the coupling slot 221c of the lower battery case 221 through the second coupling terminal 234. As a result, the protective circuit part 231 is electrically connected to the battery cells 10 through the first to fourth conductive plates 111, 112, 113, and 114 and the first to fourth conductive tabs 115, 116, 117, and 118. The protective circuit part 231 controls charging and discharging of the battery cells 10 through a circuit (not shown) disposed therein to prevent the battery cells 10 from being overcharged and overdischarged.

The body part 232 has a bar shape with an empty space therein. The body part 232 receives the protective circuit part 231 therein. A protruding arc shape 232d corresponding to the recessed shape of the arc shape 221d of the battery case 220 is formed on a lateral surface of the body part 232. Also, a coupling groove 232e corresponding to the protruding coupling member 221e of the battery case 220 is formed in the lateral surface of the body part 232. Here, a portion of the arc shape 232d of the body part 232 is recessed to define the coupling groove 232e. Also, an insulating resin may be molded to form the body part 232. However, aspects of the present invention are not limited thereto and the body part 232 may be formed of other suitable materials.

The first coupling terminal 233 is disposed on a lateral surface 232a of the body part 232. The first coupling terminal 233 is inserted into a slot (not shown) defined in a portable electrical device. The first coupling terminal 233 has a plate shape. A conductive tab 233a is electrically connected to the protective circuit part 231 and is exposed from the first coupling terminal 233 so that it is electrically connected to the portable electrical device.

The second coupling terminal 234 is disposed on a lateral surface 232b of the body part 232. The second coupling terminal 234 has a shape corresponding to a shape of the coupling slot 221c of the battery case 220. That is, the second coupling terminal 234 has a plate shape. The second coupling terminal 234 is inserted into the coupling slot 221c of the battery case 220. A conductive tab 234a is electrically connected to the protective circuit part 231 and is exposed from the second coupling terminal 234 so that it is electrically connected to the coupling slot 221c. Since the coupling slot 221c is electrically connected to the battery cells 10, when the PCM 230 is coupled to the battery case 220, the protective circuit part 231 is electrically connected to the battery cells 10.

Referring to FIG. 4, according to a coupling state between the battery case 220 and the PCM 230, the lateral surfaces 221a and 222a of the battery case 220 are parallel to the lateral surface 232a on which the first coupling terminal 233 of the body part 232 of the PCM 230 is disposed. Due to the above-described structure, an external structure of the battery pack 200 is simplified, and a portable electrical device suitable for the battery pack 200 is more simply designed. Also, since the PCM 230 is received into the battery case 220, the PCM 230 is firmly coupled to the battery case 220. In addition, the battery case 220 and the PCM 230 or the PCM 230 and the portable electrical device are electrically connected to each other as well as firmly physically coupled to each other by the first coupling terminal 233 and the second coupling terminal 234. Thus, in the battery pack 200 according to another embodiment, a separate detachment member for coupling the battery case 220 or the PCM 230 to the portable electrical device is not required.

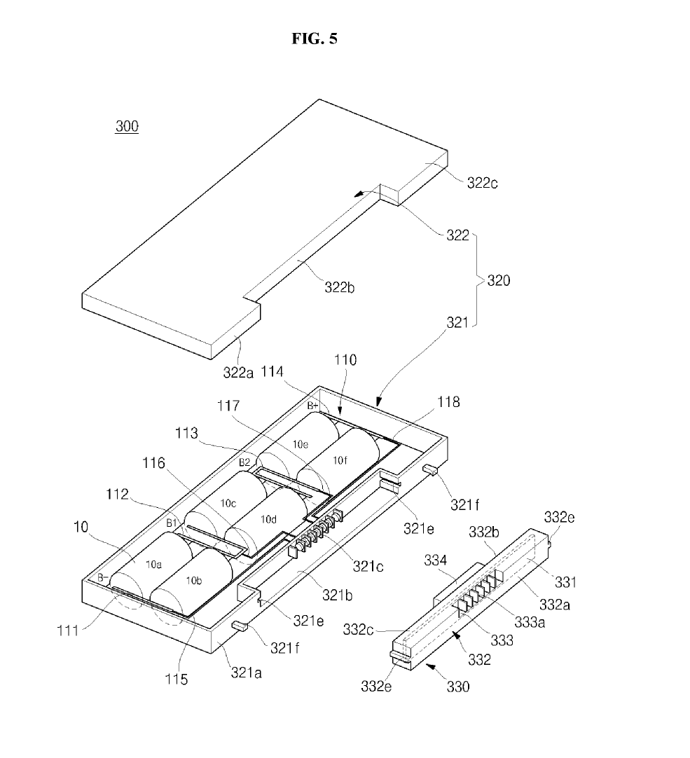

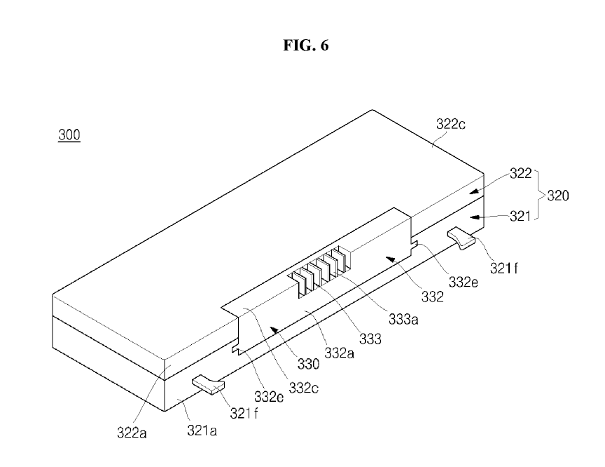

FIG. 5 illustrates an exploded perspective view of a battery pack according to another embodiment of the present invention, and FIG. 6 illustrates a perspective view of a coupling state of a battery pack according to another embodiment of the present invention. Referring to FIGS. 5 and 6, a battery pack 300 is different from the battery pack 100 of FIGS. 1 and 2 with respect to a battery case 320 and a protective circuit module (PCM) 330. Thus, in descriptions of the battery pack 300 according to the present embodiment, the battery case 320 and the PCM 330 will be mainly described. Also, parts equal to or similar to those of the battery pack 100 of FIGS. 1 and 2 have the same reference numerals, and the detailed descriptions will be omitted.

The battery case 320 includes a lower battery case 321 and an upper battery case 322. The lower battery case 321 has a box shape with an opened upper portion. The lower battery case 321 is configured to directly receive battery cells 10 and a circuit part 110. A recessed module receiving part 321b is formed in a lateral surface 321a of the lower battery case 321 to receive the PCM 330. A connector receiving part 321c is formed in a lateral surface of the module receiving part 321b. The connector receiving part 321c is electrically connected to first to fourth conductive tabs 115, 116, 117, and 118. The first to fourth conductive tabs 115, 116, 117, and 118 are electrically connected to the battery cells 10 through first to fourth conductive plates 111, 112, 113, and 114. As a result, the connector receiving part 321c is electrically connected to the battery cells 10. The connector receiving part 321c includes a plurality of cylindrical conductive tabs disposed perpendicular to a lateral surface of the lower battery case 321 in which the connector receiving part 321c is defined. Thus, the connector receiving part 321c is electrically connected to a protective circuit part 331. Inwardly recessed coupling grooves 321e are formed in both lateral surfaces of the module receiving part 321b. Also, a detachment member 321f coupling at least one portable electrical device is disposed on the lateral surface 321a of the lower battery case 321. The lower battery case 321 is formed of an insulating resin. However, aspects of the present invention are not limited thereto, and the lower battery case 321 may be formed of other suitable materials.

The upper battery case 322 has a box shape with an opened lower portion. The upper battery case 322 has a size and configuration corresponding to those of the opened upper portion of the lower battery case 321. Specifically, a module receiving part 322b for receiving the PCM 330 is formed in a lateral surface 322a of the upper battery case 322. The upper battery case 322 is formed of an insulating resin. However, aspects of the present invention are not limited thereto, and the upper battery case 322 may be formed of other suitable materials.

The PCM 330 includes a protective circuit part 331, a body part 332, a first connector 333, and a second connector 334. The protective circuit part 331 is electrically connected to the connector receiving part 321c of the lower battery case 321 through a second connector 334. As a result, the protective circuit part 331 is electrically connected to the battery cells 10 through the first through fourth conductive plates 111, 112, 113, and 114 and the first to fourth conductive tabs 115, 116, 117, and 118. The protective circuit part 331 controls charging and discharging of the battery cells 10 through a circuit (not shown) disposed therein to prevent the battery cells 10 from being overcharged and overdischarged.

The body part 332 has a bar shape with an empty space therein. The body part 332 receives the protective circuit part 331 therein. Outwardly protruding coupling protrusions 332e, each having a shape corresponding to that of the respectively coupling grooves 321e of the battery case 320, are disposed on both lateral surfaces of the body part 332. When the PCM 330 is coupled to the battery case 320, the coupling grooves 321e of the battery case 320 is coupled to the coupling protrusions 322e to further firmly couple the battery case 320 to the PCM 330.

The first connector 333 is disposed on a lateral surface 332a of the body part 332. In the first connector 333, a plurality of conductive tabs 333a having a plate shape and electrically connected to the protective circuit part 331 is disposed perpendicular to the lateral surface 332a. The first connector 333 is electrically connected to a connector receiving part (not shown) to be disposed in a portable electrical device.

The second connector 334 is disposed on another lateral surface 332b of the body part 332. The second connector 334 has a shape corresponding to that of the connector receiving part 321c of the battery case 320. In the second connector 334, a plurality of conductive tabs 333a having a plate shape and perpendicular to the other lateral surface 332b of the body part 332 is disposed so that the conductive tabs 333a contact between the cylindrical conductive tabs of the connector receiving part 321c. The conductive tabs 333a are electrically coupled to the cylindrical conductive tabs of the connector receiving part 321c. Also, the conductive tabs 333a are electrically connected to the protective circuit part 331. Since the connector receiving part 321c is electrically connected to the battery cells 10, when the PCM 330 is coupled to the battery case 320, the protective circuit part 331 is electrically connected to the battery cells 10.

Referring to FIG. 6, according to a coupling state between the battery case 320 and the PCM 330, the exposed surfaces 321a and 322a of the lateral surfaces of the battery case 320 are parallel to the lateral surface 332a on which the first connector 333 of the body part 332 of the PCM 330 is disposed. A top surface 322c of the upper battery case 322 is parallel to a top surface 332c of the PCM 330. Due to the above-described structure, an external structure of the battery pack 300 is simplified, and a portable electrical device suitable for the battery pack 300 is simply designed. Also, since the PCM 330 is received into the battery case 320, the PCM 330 is firmly coupled to the battery case 320.

Unlike the battery pack 100 of FIGS. 1 and 2, since the battery case 320, the PCM 330, and the portable electrical device are coupled to each other using a connector instead of using a slot, an outwardly protruding coupling terminal does not exist. Thus, the battery pack 300 having a clean shape and small size is designed. However, when the battery case 320, the PCM 330, and the portable electrical device are coupled using the connectors, the coupling force therebetween may be reduced when compared a coupling force using coupling terminals. Thus, to reinforce the coupling force between the battery case 320, the PCM 330, and the portable electrical device, the coupling grooves 321e of the battery case 320, the coupling protrusions of the PCM 330, and the detachment member 321f of the battery case 320 are further provided.

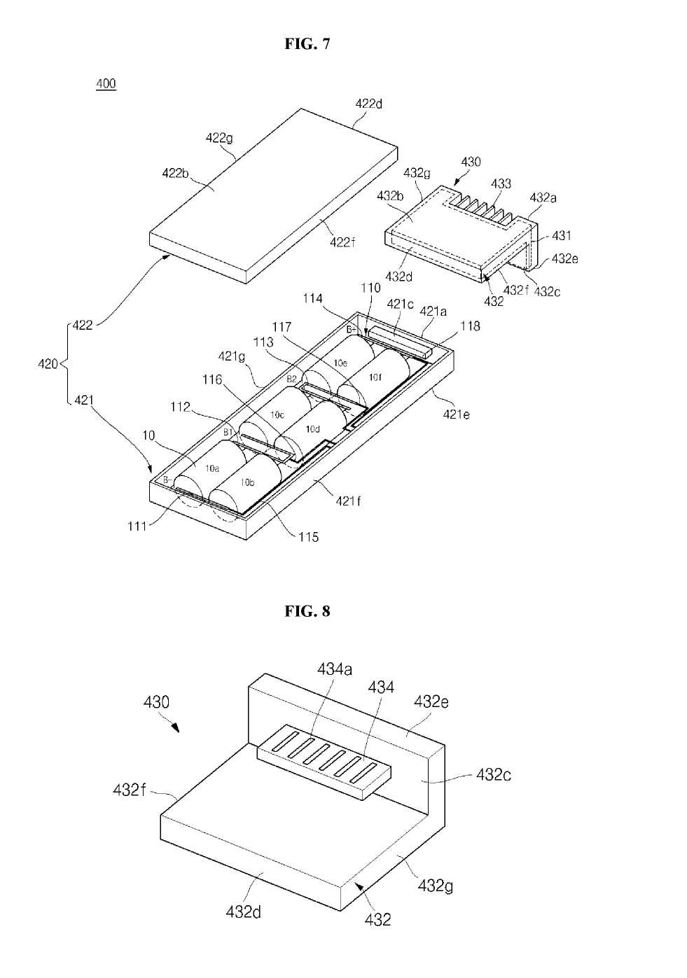

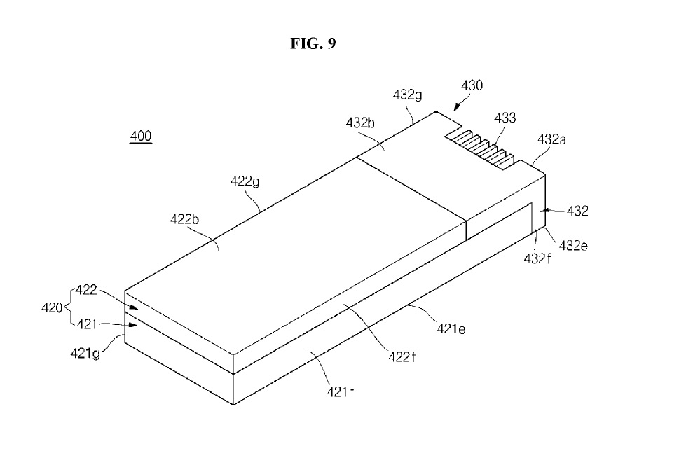

FIG. 7 illustrates an exploded perspective view of a battery pack according to another embodiment of the present invention. FIG. 8 illustrates a bottom perspective view of a PCM of a battery pack according to another embodiment of the present invention. FIG. 9 illustrates a perspective view of a coupling state of a battery pack according to another embodiment of the present invention.

Referring to FIGS. 7 to 9, a battery pack 400 is different from the battery pack 100 of FIGS. 1 and 2 in terms of structures of a battery case 420 and a protective circuit module (PCM) 430. Thus, in descriptions of the battery pack 400 according to another embodiment, the battery case 420 and the PCM 430 will be mainly described. Also, parts equal to or similar to those of the battery pack 100 of FIGS. 1 and 2 have the same reference numerals, and the detailed descriptions will be omitted.

The battery case 420 includes a lower battery case 421 and an upper battery case 422. The lower battery case 421 has a box shape with an opened upper portion. Also, the lower battery case 421 is configured to directly receive battery cells 10 and a circuit part 110. A coupling slot 421c is formed in a lateral surface 421a of the lower battery case 421 to couple the PCM 430 to the battery case 420.

The coupling slot 421c is electrically connected to first to fourth conductive tabs 115, 116, 117, and 118. The first to fourth conductive tabs 115, 116, 117, and 118 are electrically connected to the battery cells 10 through first to fourth conductive plates 111, 112, 113, and 114. As a result, the coupling slot 421c is electrically connected to the battery cells 10. A conductive tab (not shown) is electrically connected to a protective circuit part 431 and is disposed on an exposed surface within a groove of the coupling slot 421c.

The upper battery case 422 has a box shape with an opened lower portion. The upper battery case 422 covers a portion of an upper portion of the battery cells 10. That is, a lower end of the upper battery case 422 has an area less than an area of an upper end of the lower battery case 421.

The PCM 430 includes the protective circuit part 431, a body part 432, a connector 433, and a coupling terminal 434. The protective circuit part 431 is electrically connected to the coupling slot 421c of the lower battery case 421 through the coupling terminal 434. As a result, the protective circuit part 431 is electrically connected to the battery cells 10 through the first to fourth conductive plates 111, 112, 113, and 114 and the first to fourth conductive tabs 115, 116, 117, and 118. The protective circuit part 431 has an “L” shape over a portion of an upper portion of the lower battery case 421 and a lateral surface of the lower battery case 421 to optimize space utilization. Also, the protective circuit part 431 controls charging and discharging of the battery cells 10 through a circuit (not shown) disposed therein to prevent the battery cells 10 from being overcharged and overdischarged.

The body part 432 may have an “L” shape over a portion of an upper portion of the lower battery case 421 and a lateral surface of the lower battery case 421. A space is defined within the body part 432 to receive the protective circuit part 431.

The connector 433 is disposed on a surface 432a and is exposed when the body part 432 is coupled to the battery case 420. The connector 433 includes a plurality of plate-shaped conductive tabs 433a (not shown) that is electrically connected to the protective circuit part 431 and perpendicular to the surface 432a of the body part 432. The connector 433 is electrically connected to a connector receiving part (not shown) to be defined in a portable electrical device.

The coupling terminal 434 is disposed on a surface 432c, which contacts the lower battery case 421 when the coupling terminal 434 is coupled to the battery case 420 of the body part 432. The coupling terminal 434 has a shape corresponding to a shape of the coupling slot 421c of the battery case 420. That is, the coupling terminal 434 has a plate shape and is coupled to the coupling slot 421c of the battery case 420 by being inserted into the coupling slot 421c. Also, a conductive tab 434a electrically connected to the protective circuit part 431 is disposed on the coupling terminal 434 so that it is electrically connected to a conductive tab (not shown) of the coupling slot 421c. Since the coupling slot 421c is electrically connected to the battery cells 10, the protective circuit part 431 is electrically connected to the battery cells 10 when the PCM 430 is coupled to the battery case 420.

Referring to FIG. 9, according to a coupling state between the battery case 420 and the PCM 430, a lateral surface 422d of the upper battery case 422 is coupled to a lateral surface 432d (see FIG. 8) of the PCM 430. Also, a top surface 422b of the upper battery case 422 is parallel to a top surface 432b of the PCM 430. In addition, a lateral surface 421f of the lower battery case 421, a lateral surface 422f of the upper battery case 422, and a lateral surface 432f of the PCM 430 are parallel to each other. A lateral surface 421g of the lower battery case 421, a lateral surface 422g of the upper battery case 422, and a lateral surface 432g of the PCM 430 are parallel to each other. A bottom surface 421e of the lower battery case 421 and a bottom surface 432e of the PCM 430 may be parallel to each other. As a result, the PCM 430 is coupled to the battery case 420 to form a rectangular parallelepiped shape. Due to the above-described structure, a structure of the battery pack 400 is simplified, and a portable electrical device in which the battery pack 400 is disposed is simply designed. Also, in the battery pack 400, according to the present embodiment, the battery case 420 and the PCM 430 are electrically connected to each other as well as physically firmly coupled to each other by the coupling terminal 434. The protective circuit part 431 and the body part 432 each have corresponding “L” shapes. Thus, the protective circuit part 431 and the body part 432 are coupled to the lateral surface of the battery case 420 to optimize space utilization.

As described above, in the battery packs according to the above-described embodiments, the PCM in which the protective circuit part is disposed is easily decoupled from and coupled to the battery case receiving the battery cells. Thus, a design of the battery pack as a whole and a design of a space within the battery pack of a portable electrical device receiving the battery pack is simplified. Also, the battery case is separable from the PCM. As a result, in case where the battery cell is a lithium ion battery, when an electrolyte of the lithium ion battery leaks out, a short circuit of the PCM due to a contact between the PCM and the leaking electrolyte is preventable.

As described above, in the battery packs according to the above-described embodiments, since the PCM receiving the protective circuit part is easily separated and coupled, the PCM can be easily replaced according to a capacitance of the battery cell, an external environment, and user request. Also, according to a number of and dispositions of the battery cells, it is possible to independently design and modify the protective circuit part and the PCM of the battery pack. Thus, a design of the battery pack, as a whole, is simplified, and miniaturization of the battery pack is realizable.

Also, in the battery packs according to the above-described embodiments, since the PCM in which the protective circuit part is disposed is easily decoupled from and coupled to the battery case having the battery cells, in case where the battery cell is the lithium ion battery, a short circuit of the PCM due to a contact between the PCM and the leaking electrolyte is preventable when the electrolyte of the lithium ion battery leaks out.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery pack comprising:
a plurality of battery cells;
a battery case in which the battery cells are disposed;
a protective circuit part electrically connected to the battery cells; and
a protective circuit module in which the protective circuit part is disposed,
wherein the battery case and the protective circuit module are physically separable from and connectable to each other.

2. The battery pack as claimed in claim 1, wherein the battery case comprises:
a lower battery case in which the battery cells are disposed; and
an upper battery case disposed on the lower battery case to cover the battery cells.

3. The battery pack as claimed in claim 1, wherein the protective circuit module comprises:
a body part receiving the protective circuit part therein;
a first coupling terminal disposed on a lateral surface of the body part and electrically connected to a portable electrical device; and
a second coupling terminal disposed on another lateral surface of the body part and electrically connected to the battery cells.

4. The battery pack as claimed in claim 3, wherein the battery case comprises:
a lower battery case in which the battery cells are disposed;
an upper battery case disposed on the lower battery case to cover the battery cells;
a coupling slot defined in a lateral surface of the lower battery case and having an inwardly recessed groove shape to receive the second coupling terminal; and
a conductive tab disposed on an exposed surface within the groove of the coupling slot and electrically connected to the battery cells.

5. The battery pack as claimed in claim 3, wherein the battery case comprises a module receiving part disposed on a lateral surface of the battery case to receive the protective circuit module.

6. The battery pack as claimed in claim 5, wherein the battery case comprises:
a coupling slot formed on a lateral surface of the module receiving part and having an inwardly recessed groove shape to receive the second coupling terminal; and
a conductive tab disposed on an exposed surface within the groove of the coupling slot and electrically connected to the battery cells.

7. The battery pack as claimed in claim 6, wherein, when the protective circuit module is coupled to the battery case, an exposed surface of lateral surfaces of the battery case is parallel to a surface on which the first coupling terminal of the body part is disposed.

8. The battery pack as claimed in claim 6, wherein the battery case further comprises a coupling member disposed on another lateral surface of the module receiving part opposite to the lateral surface of the module receiving part in which the coupling slot is formed,
wherein the protective circuit module comprises a coupling groove formed in a shape corresponding to a shape of the coupling member of the battery case.

9. The battery pack as claimed in claim 1, wherein the protective circuit module comprises:
a body part receiving the protective circuit part;
a first connector disposed on a lateral surface of the body part and electrically connected to a portable electrical device; and
a second connector disposed on the other lateral surface of the body part and electrically connected to the plurality of battery cells.

10. The battery pack as claimed in claim 9, wherein the battery case comprises a module receiving part disposed on a lateral surface of the battery case to receive the protective circuit module.

11. The battery pack as claimed in claim 9, wherein the battery case comprises a connector receiving part disposed on a lateral surface of the module receiving part to receive the second connector, and
wherein the connector receiving part is electrically connected to the plurality of battery cells and the second connector.

12. The battery pack as claimed in claim 11, wherein, when the protective circuit module is coupled to the battery case, an exposed surface of lateral surfaces of the battery case is parallel to a surface on the protective circuit module on which a first connector of the body part is disposed.

13. The battery pack as claimed in claim 11, wherein the protective circuit module further comprises coupling protrusions protruding outwardly from both lateral surfaces of the protective circuit module,
wherein the battery case further comprises inwardly recessed coupling grooves on both lateral surfaces of the module receiving part and each having a shape corresponding to respective ones of the coupling protrusions.

14. The battery pack as claimed in claim 9, wherein the battery case comprises at least one detachment member detaching the portable electrical device.

15. A battery pack comprising:
a plurality of battery cells;
a lower battery case in which the plurality of battery cells are disposed;
an upper battery case covering a portion of the lower battery case;
a protective circuit part electrically connected to the plurality of battery cells; and
a protective circuit module receiving the protective circuit part,
wherein the protective circuit module is disposed on lateral surfaces of the lower battery case and the upper battery case covering another portion of the lower battery case not covered by the upper battery case, and
wherein the lower battery case and the protective circuit module are physically separable from and connectable to each other.

16. The battery pack as claimed in claim 15, wherein the protective circuit module comprises:
a body part receiving the protective circuit part and surrounding a portion of the lower battery case and a lateral surface of the lower battery case;
a connector disposed on an exposed surface of the body part and electrically connectable to a portable electrical device; and
a coupling terminal electrically connecting the plurality of battery cells to the protective circuit part,
wherein the coupling terminal couples the body part to the lower battery case.

17. The battery pack as claimed in claim 16, wherein the lower battery case comprises an inwardly recessed coupling slot disposed on a lateral surface to which the protective circuit part is coupled to receive the coupling terminal.

18. The battery pack as claimed in claim 17, wherein, when the protective circuit module is disposed on the lower battery case, a top surface of the upper battery case and a top surface of the protective circuit module are parallel to each other,
wherein, when the protective circuit module is coupled to the lower battery case, a lateral surface of the upper battery case, a lateral surface of the lower battery case, and a lateral surface of the protective circuit module are parallel to each other,
wherein, when the protective circuit module is coupled to the lower battery case, a bottom surface of the lower battery case and a bottom surface of the protective circuit module are parallel to each other.

19. The battery pack as claimed in claim 15, wherein the protective circuit module has a letter L shape.
